(19) United States
(12) Patent Application Publication
(10) Pub. No.: US 2024/0399900 A1
(43) Pub. Date: Dec. 5, 2024

(54) WIRELESS CHARGING SYSTEM AND ELECTRIC VEHICLE

(71) Applicant: SHENZHEN VMAX NEW ENERGY (GROUP) CO., LTD, Shenzhen (CN)

(72) Inventors: Yingying FENG, Shenzhen (CN); Shun YAO, Shenzhen (CN); Chang LIU, Shenzhen (CN)

(21) Appl. No.: 18/797,830

(22) Filed: Aug. 8, 2024

Related U.S. Application Data
(63) Continuation of application No. PCT/CN2023/096669, filed on May 26, 2023.

(30) Foreign Application Priority Data
Nov. 23, 2022 (CN) 202211477602.7

(51) Int. Cl. B60L 53/122; H02J 7/06; H02J 50/12; H02J 50/70

(52) U.S. Cl. CPC B60L 53/122; H02J 7/06; H02J 50/12; H02J 50/70; B60L 2210/30; B60L 2210/40; H02J 2207/20

(57) ABSTRACT

The present invention discloses a wireless charging system and an electric vehicle. The system comprising: a pile terminal used for wireless charging; a ground terminal, including an inverter circuit connected with the pile terminal, a first LCC compensation circuit connected with the inverter circuit, and a transmitter coil used for wireless charging; and a vehicle terminal, including a rectifier circuit connected with an on-board battery, a second LCC compensation circuit connected with the rectifier circuit, and a receiver coil matching with the transmitter coil, wherein the transmitter coil and the receiver coil are all provided with a tap structure. The present invention solves the insulation and safety control problems caused by the high voltages of the transmitter coil and the receiver coil and improves the reliability of products.

### CROSS-REFERENCE TO RELATED PATENT APPLICATION

This application is a continuation application of International Patent Application No. PCT/CN2023/096669, filed on May 26, 2023, which itself claims priority to Chinese Patent Application No. CN202211477602.7 filed in China on Nov. 23, 2022. The disclosures of the above applications are incorporated herein in their entireties by reference.

### TECHNICAL FIELD

The present invention relates to the wirelessly charging technical field of electric vehicles, in particular a wireless charging system and an electric vehicle.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In recent years, as the electric vehicle industry rapidly developed in China, it is of great significance how to enable electric vehicles to be charged safely, conveniently and quickly. A traditional approach to electric vehicles charging is to gain electricity directly from a power grid via charging stations. However, when the electric vehicles are wired for charging, it is usual to expose some parts of charging sockets or cables, when high-power charging it is easy to produce electric sparks and arcs, which bring with serious safety hazards; in addition, it is necessary for users to manually operate the traditional wired charging mode, and because of human negligence and hardware wear and tear caused by frequently inserting plugs into and extracting plugs from the charging sockets, it is easy to cause poor contact, resulting in personal safety incidents in high-power environments.

In order to solve the above problems, it is usual to adopt near filed wireless power transmission technology to realize wirelessly charging for electric vehicles. Three parts are involved in the wireless charging technology for electric vehicles, including an energy supply unit, a transmitter and a receiver. The energy supply unit is floor-mounted or wall-mounted, and inputted with an alternating current, which rectifies the alternating current into a direct current, and generates a high-frequency current from the direct current through an inverter; the transmitter is installed on the ground or underground and connected with a pile terminal through a cable, converting the high-frequency current generated by the charging pile terminal into magnetic field energy and transmitting it; the receiver is installed on the bottom of a vehicle, receiving the magnetic field energy, and charging an electric vehicle battery through rectified induced currents result from the magnetic field energy.

However, as actually designed, the currents of the transmitter coil and the receiver coil gradually increase with growing power for wireless charging, this causes the voltages at both ends of the transmitter coil and the receiver coil to reach kV. The increase in voltage causes insulation and safety control problems (safety standards) that need more time and money for verification.

Therefore, how to design a wireless charging system and an electric vehicle to solve the insulation and safety control problems caused by the high voltages of the transmitter coil and the receiver coil in the prior art is a technical problem that needs to be solved urgently in the industry.

### SUMMARY OF THE INVENTION

In view of the insulation and safety control problems caused by the high voltages of the transmitter coil and the receiver coil in the prior art, the invention proposes a wireless charging system and an electric vehicle.

The technical solutions adopted in the present invention is to provide a wireless charging system comprising: a pile terminal used for wireless charging; a ground terminal, including an inverter circuit connected with the pile terminal, a first LCC (inductor capacitor capacitor) compensation circuit connected with the inverter circuit, and a transmitter coil used for wireless charging;
and a vehicle terminal, including a rectifier circuit connected with an on-board battery, a second LCC compensation circuit connected with the rectifier circuit, and a receiver coil matching with the transmitter coil, wherein the transmitter coil and the receiver coil are all provided with a tap structure.

Further, the transmitter coil includes a first coil and a second coil that are used to form the center tap structure; a second end of the first coil is connected with a first end of the second coil to form a center tapped end; the receiver coil includes a third coil and a fourth coil that are used to form the center tap structure; the third coil is configured to match the first coil, the fourth coil is configured to match the second coil, and a second end of the third coil is connected with a first end of the fourth coil to form a center tapped end.

Further, the first LCC compensation circuit includes an inductor LF1, a capacitor CF1, a capacitor C1A and a capacitor C1B; one end of the inductor LF1 is connected to the inverter circuit, the other end of the inductor LF1 is connected with the capacitor C1A in series, then connected to a first end of the first coil; one end of the capacitor C1B is connected between the inductor LF1 and the capacitor C1A, the other end the capacitor C1B is connected to a second end of the second coil; one end of the capacitor CF1 is connected between the inductor LF1 and the capacitor C1A, and the other end the capacitor CF1 is connected to the center tapped end of the transmitter coil.

Further, the second LCC compensation circuit includes an inductor LF2, a capacitor CF2, a capacitor CA and a capacitor C2B, one end of the inductor LF2 is connected to the rectifier circuit, the other end of the inductor LF2 is connected with the capacitor C2A in series, then connected to a first end of the third coil, one end of the capacitor C2B is connected between the inductor LF2 and the capacitor C2A, the other end of the capacitor C2B is connected to a second end of the fourth coil; one end of the capacitor CF2 is connected between the inductor LF2 and the capacitor C2A, and the other end of the capacitor CF2 is connected to the center tapped end of the receiver coil.

Further, the transmitter coil includes a first coil and a second coil arranged separately, and a second end of the first coil and a first end of the second coil together serve as a center tapped end of the transmitter coil; the receiver coil includes a third coil and a fourth coil arranged separately, the third coil is configured to match the first coil; the fourth coil is configured to match the third coil, and a second end of the third coil and a first end of the fourth coil together serve as a center tapped end of the receiver coil.

Further, the first LCC compensation circuit includes an inductor LF1, a capacitor CF1, a capacitor C1A and a capacitor C1B; one end of the inductor LF1 is connected to the inverter circuit, the other end of the inductor LF1 is connected with the capacitor C1A in series, then connected to a first end of the first coil; one end of the capacitor C1B is connected between the inductor LF1 and the capacitor C1A, the other end of the capacitor C1B is connected to a second end of the second coil; one end of the capacitor CF1 is connected between the inductor LF1 and the capacitor C1A, and the other end of the capacitor CF1 is connected to a second end of the first coil and a first end of the second coil, respectively.

Further, the second LCC compensation circuit includes an inductor LF2, a capacitor CF2, a capacitor CA and a capacitor C2B; one end of the inductor LF2 is connected to the rectifier circuit, the other end of the inductor LF2 is connected with the capacitor C2A in series, then connected to a first end of the third coil, one end of the capacitor C2B is connected between the inductor LF2 and the capacitor C2A, the other end of the capacitor C2B is connected to a second end of the second coil; one end of the capacitor CF2 is connected between the inductor LF2 and the capacitor C2A, and the other end of the capacitor CF2 is connected to a second end of the third coil and a first end of the fourth coil, respectively.

Further, the transmitter coil and the receiver coil should meet the following formulas,

$$\begin{matrix}{C}_{1 A} + {L}_{BPAllk} = {C}_{1 B} + {L}_{BPBllk} ; \\ {C}_{2 A} + {L}_{VPAllk} = {C}_{2 B} + {L}_{VPBllk} ;\end{matrix}$$

where, C_{1A} is a capacitance value of the capacitor C1A, C_{1B} is a capacitance value of the capacitor C1B, C_{2A} is a capacitance value of the capacitor C2A, C_{2B} is a capacitance value of the capacitor C2B, L_{BPAllk} is a leakage inductance of the first coil, L_{BPBllk} is a leakage inductance of the second coil, L_{VPAllk} is a leakage inductance of the third coil, and L_{VPBllk} is a leakage inductance of the fourth coil.

Further, the inverter circuit includes a power switch transistor Q1, a power switch transistor Q2, a power switch transistor Q3, a power switch transistor Q4 that are used to form a full-bridge circuit, and the power switch transistor Q1 and the power switch transistor Q2 form a first bridge arm, and the power switch transistor Q3 and the power switch transistor Q4 form a second bridge arm;
drain electrodes of the power switch transistor Q1 and the power switch transistor Q3 are connected to a positive end of an input voltage Vin, source electrodes of the power switch transistor Q2 and the power switch transistor Q4 are connected to a negative end of the input voltage Vin, the inductor LF1 is connected between a source electrode of the power switch transistor Q1 and a drain electrode of the power switch transistor Q2, and the center tapped end of the transmitter coil is connected between a source electrode of the power switch transistor Q3 and a drain electrode of the power switch transistor Q4.

Further, duty ratios of the power switch transistor Q1, the power switch transistor Q2, the power switch transistor Q3 and the power switch transistor Q4 are set as 0.5, and the power switch transistor Q1 conducts with the power switch transistor Q2 in a complementary mode, and the power switch transistor Q3 conducts with the power switch transistor Q4 in a complementary mode; in addition, an output voltage of the inverter circuit is adjusted according to a phase shift angle between the power switch transistor Q2 and the power switch transistor Q4.

Further, the power switch transistor Q1 conducts with the power switch transistor Q2 in a complementary mode and the power switch transistor Q3 conducts with the power switch transistor Q4 in a complementary mode; in addition, a phase difference between the power switch transistor Q2 and the power switch transistor Q4 is set to be R, and both the transistors have a same duty ratio, and the output voltage of the inverter circuit is adjusted according to the duty ratio of the power switch transistor Q2 and the power switch transistor Q4.

Further, the rectifier circuit includes a power switch transistor Q5, a power switch transistor Q6, a power switch transistor Q7, a power switch transistor Q8 that are used to form a full-bridge circuit, and the power switch transistor Q5 and the power switch transistor Q6 form a third bridge arm, and the power switch transistor Q7 and the power switch transistor Q8 form a fourth bridge arm;
drain electrodes of the power switch transistor Q5 and the power switch transistor Q7 are connected to a positive end of an output voltage Vout, source electrodes of the power switch transistor Q6 and the power switch transistor Q8 are connected to a negative end of the output voltage Vout, the inductor LF2 is connected between a source electrode of the power switch transistor Q5 and a drain electrode of the power switch transistor Q6, and the center tapped end of the receiver coil is connected between a source electrode of the power switch transistor Q7 and a drain electrode of the power switch transistor Q8.

Further, duty ratios of the power switch transistor Q5, the power switch transistor Q6, the power switch transistor Q7 and the power switch transistor Q8 are set as 0.5, and the power switch transistor Q5 conducts with the power switch transistor Q6 in a complementary mode, and the power switch transistor Q7 conducts with the power switch transistor Q8 in a complementary mode; in addition, an input voltage of the rectifier circuit is adjusted according to a phase shift angle between the power switch transistor Q6 and the power switch transistor Q8.

Further, the power switch transistor Q5 conducts with the power switch transistor Q6 in a complementary mode and the power switch transistor Q7 conducts with the power switch transistor Q8 in a complementary mode; in addition, a phase difference between the power switch transistor Q6 and the power switch transistor Q8 is set to be π, and both the transistors have a same duty ratio, and the input voltage of the rectifier circuit is adjusted according to the duty ratio of the power switch transistor Q6 and the power switch transistor Q8.

Further, the rectifier circuit includes a diode D5, a diode D7, a power switch transistor Q6, and a power switch transistor Q8;
negative electrodes of the diode D5 and the diode D7 are connected to a positive end of an output voltage Vout; source electrodes of the power switch transistor Q6 and the power switch transistor Q8 are connected to a negative end of the output voltage Vout, and the inductor LF2 is connected between a positive electrode of the diode D5 and a drain electrode of the power switch transistor Q6, and the center tapped end of the receiver coil is connected between a positive electrode of the diode D7 and a drain electrode of the power switch transistor Q8.

Further, a phase difference between the power switch transistor Q6 and the power switch transistor Q8 is set to be π; in addition, the power switch transistor Q6 and the power switch transistor Q8 have a same duty ratio, and an input voltage of the rectifier circuit is adjusted according to the duty ratio of the power switch transistor Q6 and the power switch transistor Q8.

Further, the ground terminal meets the following formulas,

$$\begin{matrix}{C}_{F 1} * {L}_{F 1} = \frac{1}{{w}_{0}^{2}} ; \\ {L}_{BPA} = {L}_{BPAllk} + {L}_{m} ; \\ {L}_{BPB} = {L}_{BPBllk} + {L}_{m} ; \\ {C}_{IA} + {L}_{BPAllk} = {C}_{1 B} + {L}_{BPBllk} = \frac{1}{{w}_{0}^{2}} ;\end{matrix}$$

where, C_{F1} is a capacitance value of the capacitor CF1, C_{1A} is a capacitance value of the capacitor C1A, C_{1B} is a capacitance value of the capacitor C1B, L_{F1} is an inductance of the inductor LF1, L_{BPA} is an inductance of the first coil, L_{BPB} is an inductance of the second coil, and W₀ is a resonant angle frequency of the capacitor Cf1 and the inductor LF1, L_{BPAllk} is a leakage inductance of the first coil, L_{BPBllk} is a leakage inductance of the second coil, and Lₘ is a mutual inductance of the transmitter coil and the receiver coil.

Further, the vehicle terminal meets the following formulas,

$$\begin{matrix}{C}_{F 2} * {L}_{F 2} = \frac{1}{{w}_{0}^{2}} ; \\ {L}_{VPA} = {L}_{VPAllk} + {L}_{m} ; \\ {L}_{VPB} = {L}_{VPBllk} + {L}_{m} ; \\ {C}_{2 A} + {L}_{VPAllk} = {C}_{2 B} + {L}_{VPBllk} = \frac{1}{{w}_{0}^{2}} ;\end{matrix}$$

where, C_{F2} is a capacitance value of the capacitor CF2, C_{2A} is a capacitance value of the capacitor C2A, C_{2B} is a capacitance value of the capacitor C2B, L_{F2} is an inductance of the inductor LF2, L_{vPA} is an inductance of the third coil, L_{VPB} is an inductance of the fourth coil, and W₀ is a resonant angle frequency of the capacitor Cf1 and the inductor LF1, L_{VPAllk} is a leakage inductance of the third coil, L_{VPBllk} is a leakage inductance of the fourth coil, and Lₘ is a mutual inductance of the transmitter coil and the receiver coil.

The present invention further provides an electric vehicle having the wireless charging system as above.

Compared with the prior art, the present invention has at least the following beneficial effects.

In the present invention, the transmitter coil and the receiver coil are provided with a tap structure, which can enable the voltages of the transmitter coil and the receiver coil to decrease by one time, solving the insulation and safety control problems caused by the high voltages of the transmitter coil and the receiver coil, improving the reliability of products and reducing development costs and material costs for products.

### BRIEF DESCRIPTION OF THE DRAWINGS

In order to explain the technical solutions in the embodiments of the present invention or the prior art more clearly, the drawings needing to be used in the descriptions of the embodiments or the prior art are briefly introduced hereinafter. Obviously, the drawings in the following descriptions are only exemplary, and for those of ordinary skills in the art, other drawings may also be derived and obtained based on the provided drawings without going through any creative work.

FIG. 1 is a connection diagram of the wireless charging system in the present invention.

FIG. 2 is a connection diagram of the wireless charging system in another example of the present invention.

FIG. 3 is a connection diagram of the inverter circuit of the present invention.

FIG. 4 is a control timing diagram of the inverter circuit of the present invention.

FIG. 5 is a control timing diagram of the inverter circuit in another example of the present invention.

FIG. 6 is a connection diagram of the rectifier circuit in the present invention.

FIG. 7 is a control timing diagram of the rectifier circuit in the present invention.

FIG. 8 is a control timing diagram of the rectifier circuit in another example of the present invention.

FIG. 9 is a connection diagram of the rectifier circuit in another example of the present invention.

FIG. 10 is a control timing diagram of the rectifier circuit in the example in FIG. 9.

### DETAILED DESCRIPTION OF SOME EMBODIMENTS

In order to make the technical problem, technical solution and beneficial effect to be solved by the present invention more clearly understood, we shall further describe the present invention in detail in combination with the drawings and examples as follows. It should be understood that the specific examples described herein are only used to explain the present invention, not to pose a limitation on the present invention.

Therefore, occurrence of a technical feature in one example herein does not imply that all examples involved in the present invention must have this technical feature. Although some technical features can be combined to illustrate possible system designs, they can also be used in other combinations that are not explicitly stated. Unless otherwise specified, the combination of technical features in the examples is not intended to pose a limitation on the present invention.

We shall describe the principle and structure of the present invention in detail in combination with the drawings and examples as follows.

In order to solve the problem that high-power charging is easy to produce electric sparks and arcs, which bring with serious safety hazards in the prior art, it is usual to adopt near filed wireless power transmission technology to realize wirelessly electric vehicles charging. However, the currents of the transmitter coil and the receiver coil gradually increases with growing power for wireless charging, this causes the voltages at both ends of the transmitter coil and the receiver coil to reach kV, thus the increase in voltage causes insulation and safety control problems. The idea of the present invention is that the transmitter coil and the receiver coil are replaced with a tap structure, which can enable the voltages of the transmitter coil and the receiver coil to decrease by one time.

The wireless charging system proposed by the present invention includes a pile terminal used for wireless charging, a ground terminal, and a vehicle terminal, wherein the pile terminal is used as an energy supply unit, which is generally floor-mounted or wall-mounted, and input with AC mains, rectifying an alternating current into a direct current, and generating high-frequency currents through an inverter;
the ground terminal acting as a transmitter is installed on the ground or underground and connected with the pile terminal through a cable, converting the high-frequency currents generated by the pile terminal into magnetic field energy and transmitting it;
the vehicle terminal acting as a receiver is installed on the bottom of a vehicle, receiving the magnetic field energy, and charging an electric vehicle battery through rectified induced currents result from the magnetic field energy.

The pile terminal, the ground terminal, and the vehicle terminal cooperate with each other, so it is achievable to realize wirelessly electric vehicles charging and avoid the electric arcs and electric sparks caused by high-power charging.

Further, the ground terminal includes an inverter circuit connected with the pile terminal, a first LCC compensation circuit connected with the inverter circuit, and a transmitter coil used for wireless charging.

The vehicle terminal includes a rectifier circuit connected with an on-board battery, a second LCC compensation circuit connected with the rectifier circuit, and a receiver coil matching with the transmitter coil.

When the wireless charging system operates, the inverter circuit can convert the direct current transmitted by the pile terminal into the alternating current, which the first LCC compensation circuit compensates for, and transmits to the receiver coil through the transmitter coil; after the receiver coil receives the energy transmitted by the transmitter coil, the second LCC compensation circuit compensates for the alternating current, which is finally rectified by the rectifier circuit into direct current for charging the on-board battery, so as to realize the function of wirelessly charging on-board batteries.

In order to solve the problems of electric arcs and electric sparks that may occur in the process of wireless charging, the transmitter coil and the receiver coil are all provided with a tap structure in the present invention.

In one example of the present invention, the transmitter coil includes a first coil and a second coil that are used to form a center tap structure, wherein a second end of the first coil is connected with a first end of the second coil to form a center tapped end; the receiver coil includes a third coil and a fourth coil that are used to form a center tap structure, wherein the third coil is configured to match the first coil, the fourth coil is configured to match the second coil, and a second end of the third coil is connected with a first end of the fourth coil to form a center tapped end.

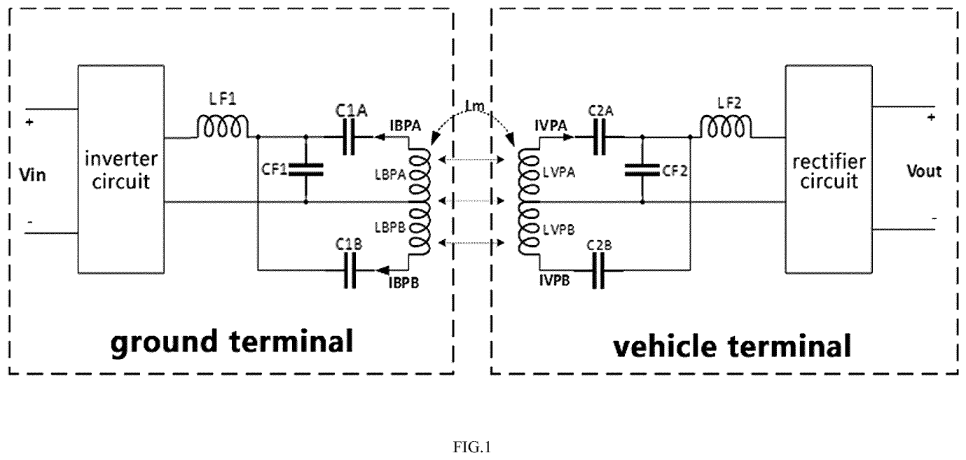

Referring to FIG. 1, which is a connection diagram of the wireless charging system in this example, LBPA is the first coil, LBPB is the second coil, LVPA is the third coil, LVPB is the fourth coil; an inductor LF1, a capacitor CF1, a capacitor C1A and a capacitor C1B form a first LCC compensation circuit; an inductor LF2, a capacitor CF2, a capacitor CA and a capacitor C2B form a second LCC compensation circuit, wherein:
in the first LCC compensation circuit, one end of the inductor LF1 is connected to the inverter circuit, the other end of the inductor LF1 is connected with the capacitor C1A in series, then connected to the first end of the first coil; one end of the capacitor C1B is connected between the inductor LF1 and the capacitor C1A, the other end of the capacitor C1B is connected to the second end of the second coil; one end of the capacitor CF1 is connected between the inductor LF1 and the capacitor C1A, and the other end of the capacitor CF1 is connected to the center tapped end of the transmitter coil;
in the second LCC compensation circuit, one end of the inductor LF2 is connected to the rectifier circuit, the other end of the inductor LF2 is connected with the capacitor C2A in series, then connected to a first end of the third coil, one end of the capacitor C2B is connected between the inductor LF2 and the capacitor C2A, the other end of the capacitor C2B is connected to the second end of the fourth coil; one end of the capacitor CF2 is connected between the inductor LF2 and the capacitor C2A, and the other end of the capacitor CF2 is connected to the center tapped end of the receiver coil.

Lm is defined as a mutual inductance of a loosely coupled transformer (a transformer composed of the transmitter coil and the receiver coil), and LBPAllk represents a leakage inductance of LBPA, LBPBllk represents a leakage inductance of LBPB, LVPAllk represents a leakage inductance of LVPA, and LVPBllk represents a leakage inductance of LVPB.

It is possible to get the following formulas.

$$\begin{matrix}{L}_{BPA} = {L}_{BPllk} + {L}_{m} ; \\ {L}_{BPB} = {L}_{BPBllk} + {L}_{m} ; \\ {L}_{VPA} = {L}_{VPAllk} + {L}_{m} ; \\ {L}_{VPB} = {L}_{VPBllk} + {L}_{m} ;\end{matrix}$$

Given: VAB is a fundamental voltage obtained after passing an input voltage Vin through the inverter circuit, that is, an output voltage of the inverter circuit, and Vab is a fundamental voltage obtained before passing an output voltage Vout through the inverter circuit, that is, an input voltage of the inverter circuit; According to the Fourier decomposition, it is possible to deduce the following formulas.

$$\begin{matrix}{V}_{A B} = {V}_{i n} * \frac{2 \sqrt{2}}{π} ; \\ {V}_{a b} = {V}_{o u f} * \frac{2 \sqrt{2}}{π} ;\end{matrix}$$

In the above components, a relation involved in all impedance is shown as follows.

$$\begin{matrix}{C}_{F 1} * {L}_{F 1} = \frac{1}{{w}_{0}^{2}} ; \\ {C}_{F 2} * {L}_{F 2} = \frac{1}{{w}_{0}^{2}} ; \\ ( \frac{( {C}_{1 A} + {L}_{BPAllk} ) * ( {C}_{1 B} + {L}_{BPBllk} )}{{C}_{1 A} + {L}_{BPAllk +} {C}_{1 B} + {L}_{BPBllk}} + {L}_{m} ) * {C}_{F 1} = \frac{1}{{w}_{0}^{2}} ; \\ ( \frac{( {C}_{2 A} + {L}_{VPAllk} ) * ( {C}_{2 B} + {L}_{VPBllk} )}{{C}_{2 A} + {L}_{VPAllk} + {C}_{2 B} + {L}_{VPBllk}} + {L}_{m} ) * {C}_{F 2} = \frac{1}{{w}_{0}^{2}} ;\end{matrix}$$

Where, W₀ represents a resonant angle frequency of the inductor LF1 and capacitor CF1 (W₀ also represents a resonant angle frequency of the inductor LF2 and capacitor CF2); it is possible to obtain the following formulas.

$$\begin{matrix}{C}_{1 A} + {L}_{BPAllk} = {C}_{1 B} + {L}_{BPBllk} ; \\ {C}_{2 A} + {L}_{VPAllk} = {C}_{2 B} + {L}_{VPBllk} ;\end{matrix}$$

According to the superposition theorem and the above relation, it is possible to give the following calculations.

$$\begin{matrix}{I}_{BPA} = \frac{{V}_{AB}}{\frac{\frac{( {C}_{1 A} + {L}_{BPAllk} ) * ( {C}_{1 B} + {L}_{BPBllk} )}{{C}_{1 A} + {L}_{BPAllk} + {C}_{1 B} + {L}_{BPBllk}} + {L}_{m}}{2}} = \frac{{V}_{AB} * \frac{1}{2}}{{w}_{0} * {L}_{F 1}} ; \\ {I}_{BPB} = \frac{{V}_{AB}}{\frac{\frac{( {C}_{1 A} + {L}_{BPAllk} ) * ( {C}_{1 B} + {L}_{BPBllk} )}{{C}_{1 A} + {L}_{BPAllk} + {C}_{1 B} + {L}_{BPBllk}} + {L}_{m}}{2}} = \frac{{V}_{AB} * \frac{1}{2}}{{w}_{0} * {L}_{F 1}} ; \\ {I}_{VPA} = \frac{{V}_{ab}}{\frac{\frac{( {C}_{2 A} + {L}_{BPAllk} ) * ( {C}_{2 B} + {L}_{BPBllk} )}{{C}_{2 A} + {L}_{BPAllk} + {C}_{2 B} + {L}_{BPBllk}} + {L}_{m}}{2}} = \frac{{V}_{ab} * \frac{1}{2}}{{w}_{0} * {L}_{F 2}} ; \\ {I}_{VPB} = \frac{{V}_{ab}}{\frac{\frac{( {C}_{2 A} + {L}_{VPAllk} ) * ( {C}_{2 B} + {L}_{VPBllk} )}{{C}_{2 A} + {L}_{VPAllk} + {C}_{2 B} + {L}_{VPBllk}} + {L}_{m}}{2}} = \frac{{V}_{ab} * \frac{1}{2}}{{w}_{0} * {L}_{F 2}} ;\end{matrix}$$

Then, the values of the voltage UBPA between the two ends of LBPA, the voltage UBPB between the two ends of LBPB, the voltage UVPA between the two ends of LVPA, and the voltage UVPB between the two ends of LVPB are calculated respectively, as follows.

$$\begin{matrix}{U}_{BPA} = \frac{{V}_{in} * \frac{\sqrt{2}}{π}}{{L}_{F 1}} * {L}_{B P A} ; \\ {U}_{BPB} = \frac{{V}_{in} * \frac{\sqrt{2}}{π}}{{L}_{F 1}} * {L}_{B P B} ; \\ {U}_{VPA} = \frac{{V}_{out} * \frac{\sqrt{2}}{π}}{{L}_{F 2}} * {L}_{V P A} ; \\ {U}_{VPB} = \frac{{V}_{out} * \frac{\sqrt{2}}{π}}{{L}_{F 2}} * {L}_{V P B} ;\end{matrix}$$

It can be seen from the above that, compared with the traditional LCC topology, in the wireless charging system proposed by the present invention, either the voltage of the transmitter coil or the voltage of the receiver coil decreases by one time, as well as the design costs for insulation and safety control possibly reduces in practical applications, enhancing the reliability of products.

In another example of the present invention, it is possible to split the transmitter coil of the center tap structure composed of LBPA and LBPB into two transmitter coils that are independently connected in parallel with each other. It is convenient for this connection to form the two coils, further reducing costs.

In this example, the transmitter coil includes a first coil and a second coil arranged separately, and the second end of the first coil and the first end of the second coil together serve as a center tapped end of the transmitter coil.

The receiver coil includes a third coil and a fourth coil arranged separately, the third coil is configured to match the first coil; the fourth coil is configured to match the third coil, and the second end of the third coil and the first end of the fourth coil together serve as a center tapped end of the receiver coil.

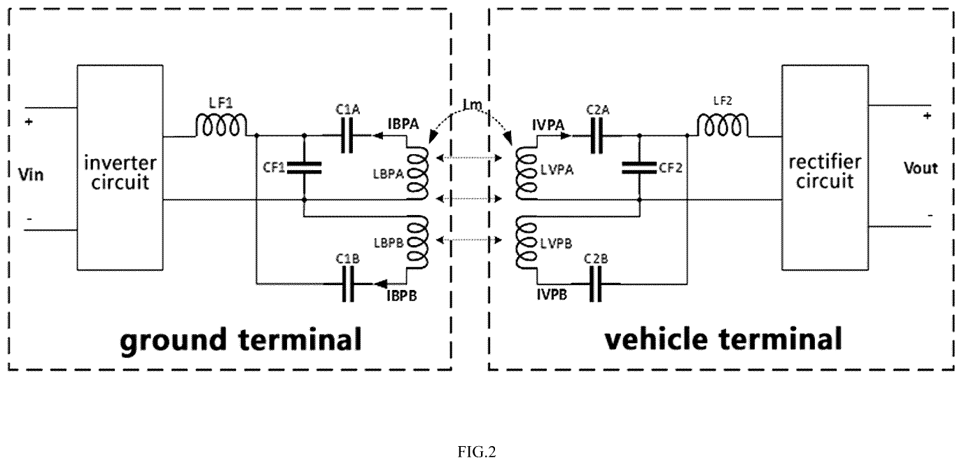

Referring to FIG. 2, in this example, in the first LCC compensation circuit, one end of the inductor LF1 is connected to the inverter circuit, the other end of the inductor LF1 is connected with the capacitor C1A in series, then connected to the first end of the first coil; one end of the capacitor C1B is connected between the inductor LF1 and the capacitor CIA, the other end of the capacitor C1B is connected to the second end of the second coil; one end of the capacitor CF1 is connected between the inductor LF1 and the capacitor C1A, and the other end of the capacitor CF1 is connected to the second end of the first coil and the first end of the second coil, respectively.

In the second LCC compensation circuit, one end of the inductor LF2 is connected to the rectifier circuit, the other end of the inductor LF2 is connected with the capacitor C2A in series, then connected to the first end of the third coil, one end of the capacitor C2B is connected between the inductor LF2 and the capacitor C2A, the other end of the capacitor C2B is connected to the second end of the second coil; one end of the capacitor CF2 is connected between the inductor LF2 and the capacitor C2A, and the other end of the capacitor CF2 is connected to the second end of the third coil and the first end of the fourth coil, respectively.

Further, as known from an analysis according to the circuit principle, when LBPA and LBPB are equal to each other, C1A and C1B are equal to each other; when LVPA and LVPB are equal to each other, C2A and C2B are equal to each other, at this time the voltages and currents between both ends of LBPA and LBPB are equal to each other, respectively, and the voltages and currents between both ends of LVPA and LVPB are equal to each other, respectively. When LVPA and LVPB are not equal to each other, there will be respectively differences in the voltages and currents between both ends of LBPA and LBPB, LVPA and LVPB; thus, in order to ensure the reliability and costs of products, we should preferentially give a guarantee that the currents of the two coils are consistent with each other.

From the process of deducing the currents of LBPA, LBPB, LVPA, LVPB above,

$$\begin{matrix}{C}_{1 A} + {L}_{BPAllk} = {C}_{1 B} + {L}_{BPBllk} ; \\ {C}_{2 A} + {L}_{VPAllk} = {C}_{2 B} + {L}_{VPBllk} ;\end{matrix}$$

it can be seen that the following equations are true when the above equations are true.

$$\begin{matrix}{C}_{1 A} + {L}_{BPA} = {C}_{1 B} + {L}_{BPB} ; \\ {C}_{2 A} + {L}_{VPA} = {C}_{2 B} + {L}_{VPB} ;\end{matrix}$$

IBPA and IBPB are equal to each other, IVPA and IVPB are equal to each other.

In this regard, in order to ensure the reliability and costs of products, in the present invention, the transmitter coil and the receiver coil should meet the following conditions.

$$\begin{matrix}{C}_{1 A} + {L}_{BPAllk} = {C}_{1 B} + {L}_{BPBllk} ; \\ {C}_{2 A} + {L}_{VPAllk} = {C}_{2 B} + {L}_{VPBllk} ;\end{matrix}$$

Where, C_{1A} is a capacitance value of the capacitor C1A, C_{1B} is a capacitance value of the capacitor C1B, C_{2A} is a capacitance value of the capacitor C2A, C_{2B} is a capacitance value of the capacitor C2B, L_{BPAllk} is a leakage inductance of the first coil, L_{BPBllk} is a leakage inductance of the second coil, L_{VPAllk} is a leakage inductance of the third coil, and L_{VPBllk} is a leakage inductance of the fourth coil.

By way of measuring the inductances of LBPA, LBPB, LVPA, and LVPB separately, it is possible to calculate C1A, C1B, C2A, and C2B according to the inductances obtained from the above measurement and the above equation, respectively, and achieve an equality between IBPA and IBPB, and an equality between IVPP and IVPB by changing the values of C1A, C1B, C2A, and C2B.

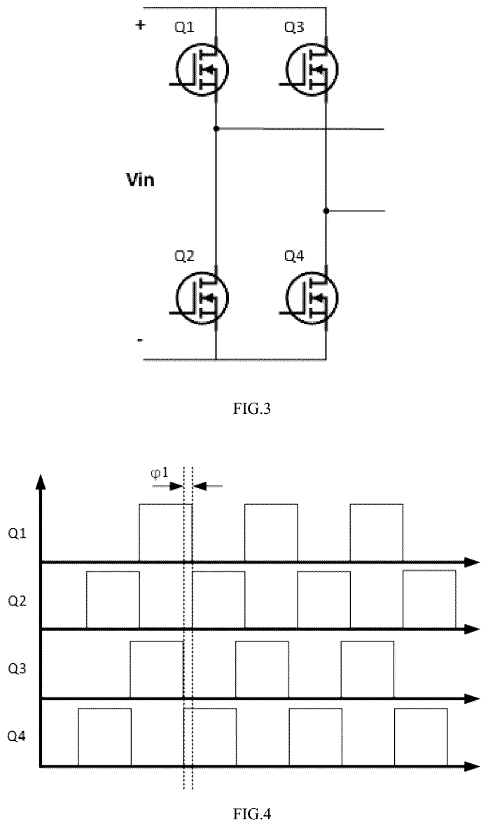

Further, in the present invention, it is possible to adjust the currents of LBPA and LBPB by changing the fundamental voltage VAB obtained after passing the input voltage Vin through the inverter circuit, we shall describe the control timing of the present invention in combination with FIG. 3 as follows.

Referring to FIG. 3, the inverter circuit in the present invention includes a power switch transistor Q1, a power switch transistor Q2, a power switch transistor Q3, a power switch transistor Q4 that are used to form a full-bridge circuit, and the power switch transistor Q1 and the power switch transistor Q2 form a first bridge arm, and the power switch transistor Q3 and the power switch transistor Q4 form a second bridge arm.

Drain electrodes of the power switch transistor Q1 and the power switch transistor Q3 are connected to a positive end of the input voltage Vin, source electrodes of the power switch transistor Q2 and the power switch transistor Q4 are connected to a negative end of the input voltage Vin, the inductor LF1 is connected between a source electrode of the power switch transistor Q1 and a drain electrode of the power switch transistor Q2, and the center tapped end of the transmitter coil is connected between a source electrode of the power switch transistor Q3 and a drain electrode of the power switch transistor Q4.

Among them, for the power switch transistor Q1˜the power switch transistor Q4, it is possible to use active devices such as MOS transistors and IGBT transistors.

Referring to FIG. 4, which is a control timing diagram of each power switch transistor in the inverter circuit. In the present invention, setting the duty ratios of the power switch transistor Q1, the power switch transistor Q2, the power switch transistor Q3 and the power switch transistor Q4 as 0.5, so that the power switch transistor Q1 conducts with the power switch transistor Q2 in a complementary mode, and the power switch transistor Q3 conducts with the power switch transistor Q4 in a complementary mode; in addition, the output voltage (fundamental voltage VAB) of the inverter circuit is adjusted according to a phase shift angle between the power switch transistor Q2 and the power switch transistor Q4.

Specifically, according to this control timing, the above inverter circuit can give the following calculation formulas according to the Fourier decomposition.

$$\begin{matrix}{V}_{A B} = {V}_{in} \frac{2 \sqrt{2}}{π} * sin ( π * {φ}_{1} ) ; \\ {I}_{BPA} = {I}_{BPB} = \frac{{V}_{AB} * \frac{1}{2}}{{w}_{0} * {L}_{F 1}} = \frac{{V}_{i n} * \frac{\sqrt{2}}{π} * sin ( π * {φ}_{1} )}{{w}_{0} * {L}_{F 1}} ;\end{matrix}$$

Where, φ₁ represents a phase shift angle between the power switch transistor Q2 and the power switch transistor Q4; it can be seen from the above formulas that by way of setting as above, the fundamental voltage VAB is only related to the input voltage Vin and the phase-shift angle φ₁, and the fundamental voltage VAB can be adjusted by means of the phase shift angle φ₁ under the condition that the input voltage Vin is unchanged.

For the same reason, as can be seen from the above formulas, the currents IBPA and IBPB in the first and second coils are only related to the input voltage Vin, the inductor LF1, and the phase shift angle φ₁, so when the input voltage Vin and the inductor LF1 remain unchanged, the currents IBPA and IBPB can be adjusted by means of the phase shift angle φ₁.

In another example of the present invention, based on the rectifier circuit proposed in FIG. 3, the present invention is also configured with another control timing. Referring to FIG. 5, the present invention is configured to enable the power switch transistor Q1 to conduct with the power switch transistor Q2 in a complementary mode and the power switch transistor Q3 to conduct with the power switch transistor Q4 in a complementary mode, as well as the phase difference between the power switch transistor Q2 and the power switch transistor Q4 to be π, so that both the transistors have the same duty ratio, and the fundamental voltage VAB is adjusted according to the duty ratio of the power switch transistor Q2 and the power switch transistor Q4.

Specifically, according to this control timing, the above inverter circuit can give the following calculation formulas according to the Fourier decomposition.

$$\begin{matrix}{V}_{A B} = {V}_{in} * \frac{2 \sqrt{2}}{π} * sin ( π * ( 1 - {D}_{1} ) ) ; \\ {I}_{BPA} = {I}_{BPB} = \frac{{V}_{AB} * \frac{1}{2}}{{w}_{0} * {L}_{F 1}} = \frac{{V}_{i n} * \frac{\sqrt{2}}{π} * sin ( π * ( 1 - {D}_{1} ) )}{{w}_{0} * {L}_{F 1}} ;\end{matrix}$$

Where, D1 represents a duty ratio of the power switch transistor Q2 and the power switch transistor Q4; it can be seen from the above formulas that by way of setting as above, the fundamental voltage VAB is only related to the input voltage Vin and the duty ratio D1, and the fundamental voltage VAB can be adjusted by means of the duty ratio D1 under the condition that the input voltage Vin is unchanged.

For the same reason, as can be seen from the above formulas, the currents IBPA and IBPB in the first and second coils are only related to the input voltage Vin, the inductor LF1, and the duty ratio D1, so when the input voltage Vin and the inductor LF1 remain unchanged, the currents IBPA and IBPB can be adjusted by means of the duty ratio D1.

Furthermore, in the present invention, the currents of LVPA and LVPB can also be adjusted by changing the fundamental voltage Vab obtained before rectifying the output voltage Vout; the control timing of the present invention is described in combination with FIG. 4;

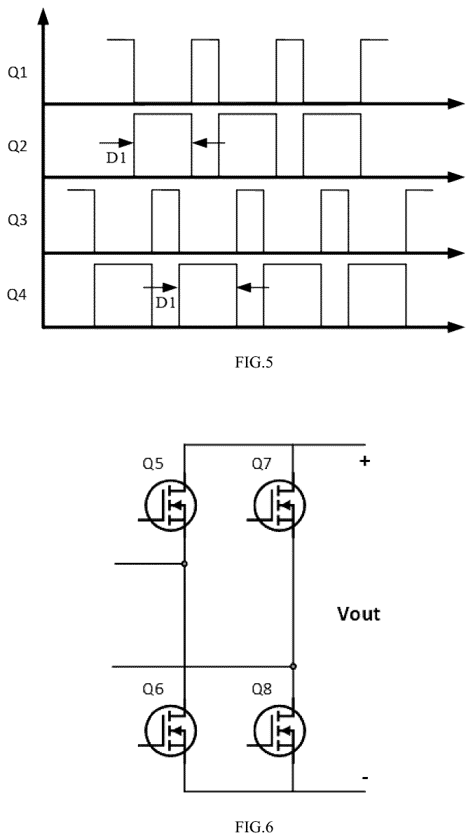

Referring to FIG. 6, the rectifier circuit in the present invention includes a power switch transistor Q5, a power switch transistor Q6, a power switch transistor Q7, a power switch transistor Q8 that are used to form a full-bridge circuit, and the power switch transistor Q5 and the power switch transistor Q6 form a third bridge arm, and the power switch transistor Q7 and the power switch transistor Q8 form a fourth bridge arm.

Drain electrodes of the power switch transistor Q5 and the power switch transistor Q7 are connected to a positive end of the output voltage Vout, source electrodes of the power switch transistor Q6 and the power switch transistor Q8 are connected to a negative end of the output voltage Vout, the inductor LF2 is connected between a source electrode of the power switch transistor Q5 and a drain electrode of the power switch transistor Q6, and the center tapped end of the receiver coil is connected between a source electrode of the power switch transistor Q7 and a drain electrode of the power switch transistor Q8.

Among them, for the power switch transistor Q5˜the power switch transistor Q8, it is possible to use active devices such as MOS transistors and IGBT transistors.

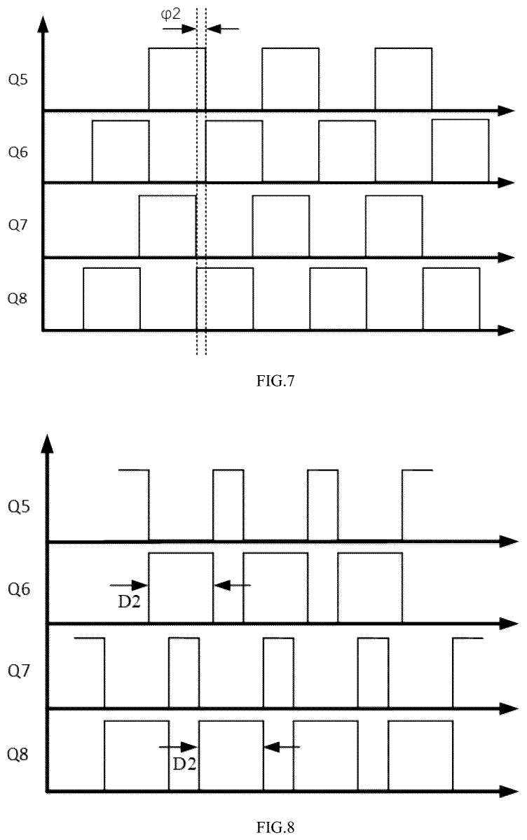

Referring to FIG. 7, which is a control timing diagram of each power switch transistor in the rectifier circuit. In the present invention, setting the duty ratios of the power switch transistor Q5, the power switch transistor Q6, the power switch transistor Q7 and the power switch transistor Q8 as 0.5, so that the power switch transistor Q5 conducts with the power switch transistor Q6 in a complementary mode, and the power switch transistor Q7 conducts with the power switch transistor Q8 in a complementary mode; in addition, the output voltage (fundamental voltage Vab) of the rectifier circuit is adjusted according to a phase shift angle between the power switch transistor Q6 and the power switch transistor Q8.

Specifically, according to this control timing, the above rectifier circuit can give the following calculation formulas according to the Fourier decomposition.

$$\begin{matrix}{V}_{a b} = {V}_{out} * \frac{2 \sqrt{2}}{π} * sin ( π * {φ}_{2} ) ; \\ {I}_{VPA} = {I}_{VPB} = \frac{{V}_{ab} * \frac{1}{2}}{{w}_{0} * {L}_{F 2}} = \frac{{V}_{o u t} * \frac{\sqrt{2}}{π} * sin ( π * {φ}_{2} )}{{w}_{0} * {L}_{F 2}} ;\end{matrix}$$

Where, φ₂ represents a phase shift angle between the power switch transistor Q6 and the power switch transistor Q8; it can be seen from the above formulas that by way of setting as above, the fundamental voltage Vab is only related to the output voltage Vout and the phase-shift angle φ₂, and the fundamental voltage Vab can be adjusted by means of the phase shift angle φ₂ under the condition that the output voltage Vout is unchanged.

For the same reason, as can be seen from the above formulas, the currents IVPA and IVPB in the third and fourth coils are only related to the output voltage Vout, the inductor LF2, and the phase shift angle φ₂, so when the output voltage Vout and the inductor LF2 remain unchanged, the currents IVPA and IVPB can be adjusted by means of the phase shift angle φ₂.

In another example of the present invention, based on the rectifier circuit proposed in FIG. 6, the present invention is also configured with another control timing. Referring to FIG. 8, the present invention is configured to enable the power switch transistor Q5 to conduct with the power switch transistor Q6 in a complementary mode and the power switch transistor Q7 to conduct with the power switch transistor Q8 in a complementary mode, as well as the phase difference between the power switch transistor Q6 and the power switch transistor Q8 to be π, so that both the transistors have the same duty ratio, and the fundamental voltage Vab is adjusted according to the duty ratio of the power switch transistor Q6 and the power switch transistor Q8.

Specifically, according to this control timing, the above rectifier circuit can give the following calculation formulas according to the Fourier decomposition.

$$\begin{matrix}{V}_{a b} = {V}_{out} * \frac{2 \sqrt{2}}{π} * sin ( π * ( 1 - {D}_{2} ) ) ; \\ {I}_{VPA} = {I}_{VPB} = \frac{{V}_{ab} * \frac{1}{2}}{{w}_{0} * {L}_{F 2}} = \frac{{V}_{o u t} * \frac{\sqrt{2}}{π} * sin ( π * ( 1 - {D}_{2} ) )}{{w}_{0} * {L}_{F 2}} ;\end{matrix}$$

Where, D2 represents a duty ratio of the power switch transistor Q6 and the power switch transistor Q8; it can be seen from the above formulas that by way of setting as above, the fundamental voltage Vab is only related to the output voltage Vout and the duty ratio D2, and the fundamental voltage Vab can be adjusted by means of the duty ratio D2 under the condition that the output voltage Vout is unchanged.

For the same reason, as can be seen from the above formulas, the currents IVPA and IVPB in the third and fourth coils are only related to the output voltage Vout, the inductor LF2, and the duty ratio D2, so when the output voltage Vout and the inductor LF2 remain unchanged, the currents IVPA and IVPB can be adjusted by means of the duty ratio D2.

Referring to FIG. 9, in another example of the present invention, the rectifier circuit includes a diode D5, a diode D7, a power switch transistor Q6, and a power switch transistor Q8.

Negative electrodes of the diode D5 and the diode D7 are connected to a positive end of the output voltage Vout; source electrodes of the power switch transistor Q6 and the power switch transistor Q8 are connected to a negative end of the output voltage Vout, and the inductor LF2 is connected between a positive electrode of the diode D5 and a drain electrode of the power switch transistor Q6, and the center tapped end of the receiver coil is connected between a positive electrode of the diode D7 and a drain electrode of the power switch transistor Q8.

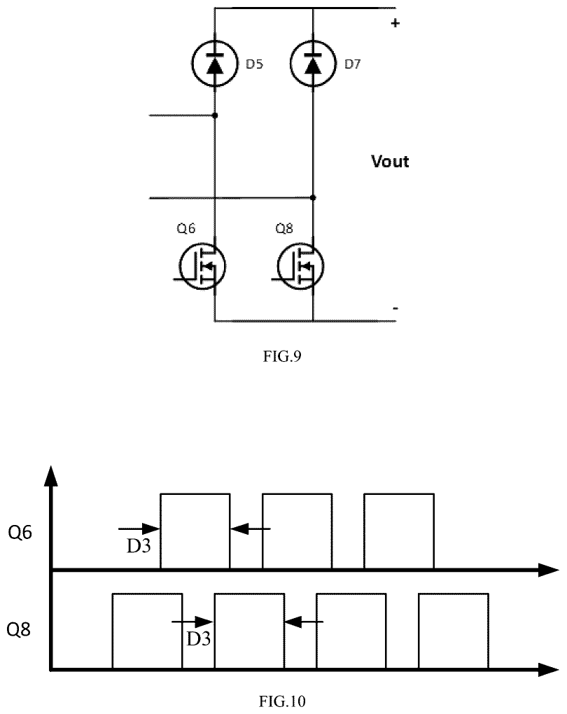

Further, in another example of the present invention, based on the rectifier circuit proposed in FIG. 9, the present invention is also configured with another control timing. Referring to FIG. 10, the present invention is configured to enable the phase difference between the power switch transistor Q6 and the power switch transistor Q8 to be π, so that both the transistors have the same duty ratio, and the input voltage (fundamental voltage Vab) of the rectifier circuit is adjusted according to the duty ratio of the power switch transistor Q6 and the power switch transistor Q8.

Specifically, according to this control timing, the above rectifier circuit can give the following calculation formulas according to the Fourier decomposition.

$$\begin{matrix}{V}_{a b} = {V}_{out} * \frac{2 \sqrt{2}}{π} * sin ( π * ( 1 - {D}_{3} ) ) ; \\ {I}_{VPA} = {I}_{VPB} = \frac{{V}_{ab} * \frac{1}{2}}{{w}_{0} * {L}_{F 2}} = \frac{{V}_{o u t} * \frac{\sqrt{2}}{π} * sin ( π * ( 1 - {D}_{3} ) )}{{w}_{0} * {L}_{F 2}} ;\end{matrix}$$

Where, D3 represents a duty ratio of the power switch transistor Q6 and the power switch transistor Q8; it can be seen from the above formulas that by way of setting as above, the fundamental voltage Vab is only related to the output voltage Vout and the duty ratio D3, and the fundamental voltage Vab can be adjusted by means of the duty ratio D3 under the condition that the output voltage Vout is unchanged.

For the same reason, as can be seen from the above formulas, the currents IVPA and IVPB in the third and fourth coils are only related to the output voltage Vout, the inductor LF2, and the duty ratio D3, so when the output voltage Vout and the inductor LF2 remain unchanged, the currents IVPA and IVPB can be adjusted by means of the duty ratio D3.

Further, in order to realize the above function, each device in the ground terminal of the present invention should meet the following conditions.

$$\begin{matrix}{C}_{F 1} * {L}_{F 1} = \frac{1}{{w}_{0}^{2}} ; \\ {L}_{BPA} = {L}_{BPAllk} + {L}_{m} ; \\ {L}_{BPB} = {L}_{BPBllk} + {L}_{m} ; \\ {C}_{1 A} + {L}_{BPAllk} = {C}_{1 B} + {L}_{BPBllk} = \frac{1}{{w}_{0}^{2}} ;\end{matrix}$$

Where, C_{F1} is a capacitance value of the capacitor CF1, C_{1A} is a capacitance value of the capacitor C1A, C_{1B} is a capacitance value of the capacitor C1B, L_{F1} is an inductance of the inductor LF1, L_{BPA} is an inductance of the first coil, L_{BPB} is an inductance of the second coil, and W₀ is a resonant angle frequency of the capacitor CF1 and the inductor LF1, L_{BPAllk} is a leakage inductance of the first coil, L_{BPBllk} is a leakage inductance of the second coil, and Lₘ is a mutual inductance of the transmitter coil and the receiver coil.

Specifically, in a preferred embodiment of the present invention, the inductance of the first coil and the second coil is set to be 40 uH, and the inductance of the inductor LF1 is set to be 20 uH, and the capacitance value of the capacitor CF1 can be given according to the relation of

$${C}_{F 1} * {L}_{F 1} = \frac{1}{{w}_{0}^{2}} ;$$

The present invention is configured to set the mutual inductances of the transmitter coil and the receiver coil to be 6 uH, according to the following relation equations,

$$\begin{matrix}{L}_{BPA} = {L}_{BPAllk} + {L}_{m} ; \\ {L}_{BPB} = {L}_{BPBllk} + {L}_{m} ;\end{matrix}$$

it is possible to give leakage inductances of the first coil and the second coil, respectively; and finally, according to the following relation equations,

$${C}_{1 A} + {L}_{BPAllk} = {C}_{1 B} + {L}_{BPBllk} = \frac{1}{{w}_{0}^{2}} ;$$

it is possible to give capacitance values of the capacitor C1A and the capacitor C1B, respectively; thus, all parameters of the ground terminal have been designed.

Similarly, each device in the vehicle terminal should meet the following conditions.

$$\begin{matrix}{C}_{F 2} * {L}_{F 2} = \frac{1}{{w}_{0}^{2}} ; \\ {L}_{VPA} = {L}_{VPAllk} + {L}_{m} ; \\ {L}_{VPB} = {L}_{VPBllk} + {L}_{m} ; \\ {C}_{2 A} + {L}_{VPAllk} = {C}_{2 B} + {L}_{VPBllk} = \frac{1}{{w}_{0}^{2}} ;\end{matrix}$$

Where, C_{F2} is a capacitance value of the capacitor CF2, C_{2A} is a capacitance value of the capacitor C2A, C_{2B} is a capacitance value of the capacitor C2B, L_{F2} is an inductance of the inductor LF2, L_{vPA} is an inductance of the third coil, L_{VPB} is an inductance of the fourth coil, and W₀ is a resonant angle frequency of the capacitor CF1 and the inductor LF1 (the resonant angle frequency of the capacitor CF2 and the inductor LF2 is same as the resonant angle frequency of the capacitor CF1 and the inductor LF1, each of the two is W0), L_{VPAllk} is a leakage inductance of the third coil, L_{VPBllk} is a leakage inductance of the fourth coil, and Lₘ is a mutual inductance of the transmitter coil and the receiver coil.

Specifically, in a preferred embodiment of the present invention, the inductances of the third coil and the fourth coil are set to be 40 uH, and the inductance of the inductor LF2 is set to be 20 uH, and the capacitance value of the capacitor CF2 can be given according to the relation of

$${C}_{F 2} * {L}_{F 2} = \frac{1}{{w}_{0}^{2}} .$$

The present invention is configured to set the mutual inductances of the transmitter coil and the receiver coil to be 6 uH, according to the following relation equations,

$$\begin{matrix}{L}_{VPA} = {L}_{VPAllk} + {L}_{m} \\ {L}_{VPB} = {L}_{VPBllk} + {L}_{m}\end{matrix}$$

it is possible to give leakage inductances of the third coil and the fourth coil, respectively; and finally, according to the following relation equation,

$${C}_{2 A} + {L}_{VPAllk} = {C}_{2 B} + {L}_{VPBllk} = \frac{1}{{w}_{0}^{2}} ;$$

it is possible to give capacitance values of the capacitor C2A and the capacitor C2B, respectively; thus, all parameters of the vehicle terminal have been designed.

The invention also proposes an electric vehicle, which adopts the wireless charging system described above.

Further, the electric vehicle includes at least a low-speed four-wheeled electric vehicle, a low-speed two-wheeled electric vehicle, a low-speed logistics vehicle, a four-wheeled passenger vehicle, a four-wheeled commercial vehicle and the likes.

Compared with the prior art, in the present invention, the transmitter coil and the receiver coil are provided with a tap structure, which can enable the voltages of the transmitter coil and the receiver coil to decrease by one time, solving the insulation and safety control problems caused by the high voltages of the transmitter coil and the receiver coil, improving the reliability of products and reducing development costs and material costs for products.

The above content only acts as a better embodiment of the present invention, not used to pose any limitation on the present invention, and any modifications, equivalent substitutions, improvements and the likes made within the essence and principle of the present invention will fall within the protection scope of the present invention.

What is claimed is:

1. A wireless charging system comprising:
a pile terminal used for wireless charging;
a ground terminal, including an inverter circuit connected with the pile terminal, a first LCC compensation circuit connected with the inverter circuit, and a transmitter coil used for wireless charging;
and a vehicle terminal, including a rectifier circuit connected with an on-board battery, a second LCC compensation circuit connected with the rectifier circuit, and a receiver coil matching with the transmitter coil,
wherein the transmitter coil and the receiver coil are all provided with a tap structure.

2. The wireless charging system according to claim 1, wherein the transmitter coil comprises a first coil and a second coil that are used to form the center tap structure; a second end of the first coil is connected with a first end of the second coil to form a center tapped end;
the receiver coil comprises a third coil and a fourth coil that are used to form the center tap structure; the third coil is configured to match the first coil, the fourth coil is configured to match the second coil, and a second end of the third coil is connected with a first end of the fourth coil to form a center tapped end.

3. The wireless charging system according to claim 2, wherein the first LCC compensation circuit comprises an inductor LF1, a capacitor CF1, a capacitor CIA and a capacitor C1B; one end of the inductor LF1 is connected to the inverter circuit, the other end of the inductor is connected with the capacitor C1A in series, then connected to a first end of the first coil; one end of the capacitor C1B is connected between the inductor LF1 and the capacitor C1A, the other end of the capacitor is connected to a second end of the second coil; one end of the capacitor CF1 is connected between the inductor LF1 and the capacitor C1A, and the other end of the capacitor CF1 is connected to the center tapped end of the transmitter coil.

4. The wireless charging system according to claim 3, wherein the second LCC compensation circuit comprises an inductor LF2, a capacitor CF2, a capacitor CA and a capacitor C2B, one end of the inductor LF2 is connected to the rectifier circuit, the other end of the inductor LF2 is connected with the capacitor C2A in series, then connected to a first end of the third coil, one end of the capacitor C2B is connected between the inductor LF2 and the capacitor C2A, the other end of the capacitor C2B is connected to a second end of the fourth coil; one end of the capacitor CF2 is connected between the inductor LF2 and the capacitor C2A, and the other end of the capacitor CF2 is connected to the center tapped end of the receiver coil.

5. The wireless charging system according to claim 1, wherein the transmitter coil comprises a first coil and a second coil arranged separately, and a second end of the first coil and a first end of the second coil together serve as a center tapped end of the transmitter coil;
the receiver coil comprises a third coil and a fourth coil arranged separately, the third coil is configured to match the first coil; the fourth coil is configured to match the third coil, and a second end of the third coil and a first end of the fourth coil together serve as a center tapped end of the receiver coil.

6. The wireless charging system according to claim 5, wherein the first LCC compensation circuit comprises an inductor LF1, a capacitor CF1, a capacitor CIA and a capacitor C1B; one end of the inductor LF1 is connected to the inverter circuit, the other end of the inductor LF1 is connected with the capacitor C1A in series, then connected to a first end of the first coil; one end of the capacitor C1B is connected between the inductor LF1 and the capacitor C1A, the other end of the capacitor C1B is connected to a second end of the second coil; one end of the capacitor CF1 is connected between the inductor LF1 and the capacitor C1A, and the other end of the capacitor CF1 is connected to a second end of the first coil and a first end of the second coil, respectively.

7. The wireless charging system according to claim 6, wherein the second LCC compensation circuit comprises an inductor LF2, a capacitor CF2, a capacitor CA and a capacitor C2B; one end of the inductor LF2 is connected to the rectifier circuit, the other end of the inductor LF2 is connected with the capacitor C2A in series, then connected to a first end of the third coil, one end of the capacitor C2B is connected between the inductor LF2 and the capacitor C2A, the other end of the capacitor C2B is connected to a second end of the second coil; one end of the capacitor CF2 is connected between the inductor LF2 and the capacitor C2A, and the other end of the capacitor CF2 is connected to a second end of the third coil and a first end of the fourth coil, respectively.

8. The wireless charging system according to claim 4, wherein the transmitter coil and the receiver coil should meet the following formulas,
$$\begin{matrix}{C}_{1 A} + {L}_{BPAllk} = {C}_{1 B} + {L}_{BPBllk} ; \\ {C}_{2 A} + {L}_{VPAllk} = {C}_{2 B} + {L}_{VPBllk} ;\end{matrix}$$
where, C_{1A} is a capacitance value of the capacitor C1A, C_{1B} is a capacitance value of the capacitor C1B, C_{2A} is a capacitance value of the capacitor C2A, C_{2B} is a capacitance value of the capacitor C2B, L_{BPAllk} is a leakage inductance of the first coil, L_{BPBllk} is a leakage inductance of the second coil, L_{VPAllk} is a leakage inductance of the third coil, and L_{VPBllk} is a leakage inductance of the fourth coil.

9. The wireless charging system according to claim 4, wherein the inverter circuit comprises a power switch transistor Q1, a power switch transistor Q2, a power switch transistor Q3, a power switch transistor Q4 that are used to form a full-bridge circuit, and the power switch transistor Q1 and the power switch transistor Q2 form a first bridge arm, and the power switch transistor Q3 and the power switch transistor Q4 form a second bridge arm;
drain electrodes of the power switch transistor Q1 and the power switch transistor Q3 are connected to a positive end of an input voltage Vin, source electrodes of the power switch transistor Q2 and the power switch transistor Q4 are connected to a negative end of the input voltage Vin, the inductor LF1 is connected between a source electrode of the power switch transistor Q1 and a drain electrode of the power switch transistor Q2, and the center tapped end of the transmitter coil is connected between a source electrode of the power switch transistor Q3 and a drain electrode of the power switch transistor Q4.

10. The wireless charging system according to claim 9, wherein duty ratios of the power switch transistor Q1, the power switch transistor Q2, the power switch transistor Q3 and the power switch transistor Q4 are set as 0.5, and the power switch transistor Q1 conducts with the power switch transistor Q2 in a complementary mode, and the power switch transistor Q3 conducts with the power switch transistor Q4 in a complementary mode; in addition, an output voltage of the inverter circuit is adjusted according to a phase shift angle between the power switch transistor Q2 and the power switch transistor Q4.

11. The wireless charging system according to claim 9, wherein the power switch transistor Q1 conducts with the power switch transistor Q2 in a complementary mode and the power switch transistor Q3 conducts with the power switch transistor Q4 in a complementary mode; in addition, a phase difference between the power switch transistor Q2 and the power switch transistor Q4 is set to be π, and both the transistors have a same duty ratio, and the output voltage of the inverter circuit is adjusted according to the duty ratio of the power switch transistor Q2 and the power switch transistor Q4.

12. The wireless charging system according to claim 4, wherein the rectifier circuit comprises a power switch transistor Q5, a power switch transistor Q6, a power switch transistor Q7, a power switch transistor Q8 that are used to form a full-bridge circuit, and the power switch transistor Q5 and the power switch transistor Q6 form a third bridge arm, and the power switch transistor Q7 and the power switch transistor Q8 form a fourth bridge arm;
drain electrodes of the power switch transistor Q5 and the power switch transistor Q7 are connected to a positive end of an output voltage Vout, source electrodes of the power switch transistor Q6 and the power switch transistor Q8 are connected to a negative end of the output voltage Vout, the inductor LF2 is connected between a source electrode of the power switch transistor Q5 and a drain electrode of the power switch transistor Q6, and the center tapped end of the receiver coil is connected between a source electrode of the power switch transistor Q7 and a drain electrode of the power switch transistor Q8.

13. The wireless charging system according to claim 12, wherein duty ratios of the power switch transistor Q5, the power switch transistor Q6, the power switch transistor Q7 and the power switch transistor Q8 are set as 0.5, and the power switch transistor Q5 conducts with the power switch transistor Q6 in a complementary mode, and the power switch transistor Q7 conducts with the power switch transistor Q8 in a complementary mode; in addition, an input voltage of the rectifier circuit is adjusted according to a phase shift angle between the power switch transistor Q6 and the power switch transistor Q8.

14. The wireless charging system according to claim 12, wherein the power switch transistor Q5 conducts with the power switch transistor Q6 in a complementary mode and the power switch transistor Q7 conducts with the power switch transistor Q8 in a complementary mode; in addition, a phase difference between the power switch transistor Q6 and the power switch transistor Q8 is set to be π, and both the transistors have a same duty ratio, and the input voltage of the rectifier circuit is adjusted according to the duty ratio of the power switch transistor Q6 and the power switch transistor Q8.

15. The wireless charging system according to claim 4, wherein the rectifier circuit comprises a diode D5, a diode D7, a power switch transistor Q6, and a power switch transistor Q8;
negative electrodes of the diode D5 and the diode D7 are connected to a positive end of an output voltage Vout; source electrodes of the power switch transistor Q6 and the power switch transistor Q8 are connected to a negative end of the output voltage Vout, and the inductor LF2 is connected between a positive electrode of the diode D5 and a drain electrode of the power switch transistor Q6, and the center tapped end of the receiver coil is connected between a positive electrode of the diode D7 and a drain electrode of the power switch transistor Q8.

16. The wireless charging system according to claim 15, wherein a phase difference between the power switch transistor Q6 and the power switch transistor Q8 is set to be π; in addition, the power switch transistor Q6 and the power switch transistor Q8 have a same duty ratio, and an input voltage of the rectifier circuit is adjusted according to the duty ratio of the power switch transistor Q6 and the power switch transistor Q8.

17. The wireless charging system according to claim 4, wherein the ground terminal meets the following formulas,
$$\begin{matrix}{C}_{F 1} * {L}_{F 1} = \frac{1}{{w}_{0}^{2}} ; \\ {L}_{BPA} = {L}_{BPAllk} + {L}_{m} ; \\ {L}_{BPB} = {L}_{BPBllk} + {L}_{m} ; \\ {C}_{1 A} + {L}_{BPAllk} = {C}_{1 B} + {L}_{BPBllk} = \frac{1}{{w}_{0}^{2}} ;\end{matrix}$$
where, C_{F1} is a capacitance value of the capacitor CF1, C_{1A} is a capacitance value of the capacitor C1A, C_{1B} is a capacitance value of the capacitor C1B, L_{F1} is an inductance of the inductor LF1, L_{BPA} is an inductance of the first coil, L_{BPB} is an inductance of the second coil, and W₀ is a resonant angle frequency of the capacitor Cf1 and the inductor LF1, L_{BPAllk} is a leakage inductance of the first coil, L_{BPBllk} is a leakage inductance of the second coil, and Lₘ is a mutual inductance of the transmitter coil and the receiver coil.

18. The wireless charging system according to claim 4, the vehicle terminal meets the following formulas,
$$\begin{matrix}{C}_{F 2} * {L}_{F 2} = \frac{1}{{w}_{0}^{2}} ; \\ {L}_{VPA} = {L}_{VPAllk} + {L}_{m} ; \\ {L}_{VPB} = {L}_{VPBllk} + {L}_{m} ; \\ {C}_{2 A} + {L}_{VPAllk} = {C}_{2 B} + {L}_{VPBllk} = \frac{1}{{w}_{0}^{2}} ;\end{matrix}$$
where, C_{F2} is a capacitance value of the capacitor CF2, C_{2A} is a capacitance value of the capacitor C2A, C_{2B} is a capacitance value of the capacitor C2B, L_{F2} is an inductance of the inductor LF2, L_{IPA} is an inductance of the third coil, L_{VPB} is an inductance of the fourth coil, and W₀ is a resonant angle frequency of the capacitor Cf1 and the inductor LF1, L_{VPAllk} is a leakage inductance of the third coil, L_{VPBllk} is a leakage inductance of the fourth coil, and Lₘ is a mutual inductance of the transmitter coil and the receiver coil.

19. An electric vehicle having the wireless charging system according to claim 1.

20. An electric vehicle having the wireless charging system according to claim 4.
